(19) United States
(12) Patent Application Publication
(10) Pub. No.: US 2022/0153519 A1
(43) Pub. Date: May 19, 2022

(54) LOAD-HANDLING DEVICE

(71) Applicant: OCADO INNOVATION LIMITED, Hatfield, Hertfordshire (GB)

(72) Inventors: Daniel POPA, Hatfield, Hertfordshire (GB); Del MAYADEEN, Hatfield, Hertfordshire (GB); Matthew HARMAN, Hatfield, Hertfordshire (GB); Nick SHARP, Hatfield, Hertfordshire (GB); Vipin PILLAI, Hatfield, Hertfordshire (GB)

(73) Assignee: OCADO INNOVATION LIMITED, Hatfield, Hertfordshire (GB)

(21) Appl. No.: 17/593,604

(22) PCT Filed: Mar. 20, 2020
(86) PCT No.: PCT/EP2020/057776

§ 371 Date: Sep. 21, 2021

(30) Foreign Application Priority Data
Mar. 22, 2019 (GB) 1903982.5

(51) Int. Cl. B65G 1/04; B61B 3/00

(52) U.S. Cl. CPC B65G 1/0464; B61B 3/00

(57) ABSTRACT

A load-handling device is provided for lifting and moving containers stacked in stacks in a storage system. The load-handling device includes a body; a wheel assembly arranged to support the body; a container-lifting mechanism configured to lift a container into or out of the body; and a wheel-positioning mechanism with wheel-engaging functionality for selectively engaging either a first set of wheels of the wheel assembly with a first set of rails or tracks of the storage system, or a second set of wheels of the wheel assembly with a second set of rails or tracks of the storage system. A wheel-engaging device can include at least one non-vertically-orientated linear actuator and/or at least one eccentric-rotation-based wheel-engaging device.

The invention relates to a load-handling device. In particular, it relates to a robotic load-handling device suitable for moving one or more loads between different locations.

### BACKGROUND

Robotic load-handling devices (“robots” or “bots”) are used to move loads from one location to another. They may for example be used to move totes, boxes or other containers, e.g. within and/or in or out of a storage system, such as the storage grid 1 illustrated in FIG. 1. The illustrated storage grid 1 includes a frame structure 14 comprising a plurality of upright members 16 that support horizontal members 18, 20. A first set of parallel horizontal members 18 is arranged orthogonally to a second set of parallel horizontal members 20 to form a plurality of horizontal grid structures supported by the upright members 16. The members 16, 18, 20 are typically manufactured from metal. Containers 10 are stacked between the members 16, 18, 20 of the frame structure 14, so that the frame structure 14 guards against horizontal movement of the stacks 12 of containers 10, and guides or constrains vertical movement of the containers 10.

The illustrated storage grid 1 also includes a plurality of rails or tracks 22 arranged in a grid pattern above the stacks 12 of containers 10, the grid pattern comprising a plurality of grid spaces, each stack 12 of containers 10 being located within a footprint of only a single grid space. Bots are configured to move laterally on the rails or tracks 22 above the stacks, and to move totes relative to the grid using respective container-lifting mechanisms which allow at least one tote to be lifted into a container-receiving space of a bot.

The claimed load-handling devices, methods and computer programs are intended to provide improvements relative to known load-handling devices.

### SUMMARY

According to one embodiment, there is provided a load-handling device as claimed in claim 1. According to a further embodiment, there is provided a method as claimed in claim 10. According to another embodiment, there is provided a computer program as claimed in claim 12. According to a different embodiment, there is provided a load-handling device as claimed in claim 14. According to another embodiment, there is provided a method as claimed in claim 21. According to a still further embodiment, there is provided a computer program as claimed in claim 23. According to yet another embodiment, there is provided a load-handling device for lifting and moving containers stacked in stacks in a storage system, the storage system including a plurality of rails or tracks arranged in a grid pattern above the stacks of containers, the load-handling device being configured to move on the rails or tracks above the stacks, the load-handling device comprising: a body having an upper portion and a lower portion, the upper portion being configured to house one or more operation components, the lower portion being arranged beneath the upper portion, the lower portion comprising a container-receiving space for accommodating at least one container; a wheel assembly arranged to support the body, the wheel assembly comprising a first set of wheels for engaging with a first set of rails or tracks to guide movement of the device in a first direction and a second set of wheels for engaging with a second set of rails or tracks to guide movement of the device in a second direction, wherein the second direction is transverse to the first direction; a container-lifting mechanism, the container-lifting mechanism comprising container-engaging means configured to engage a container and lifting means configured to raise and lower the container-engaging means relative to the container-receiving space; and a wheel-positioning mechanism, the wheel-positioning mechanism comprising wheel-engaging means for selectively engaging either the first set of wheels with the first set of rails or tracks or the second set of wheels with the second set of rails or tracks, the wheel-engaging means being configured to raise or lower the first set of wheels or the second set of wheels relative to the body, thereby enabling the load-handling device to selectively move in either the first direction or the second direction across the tracks of the storage system, wherein the wheel-engaging means comprises a fluid-based wheel-engaging means.

Such a load-handling device, method or computer program may provide one or more advantages in terms of load-handling device serviceability, mechanical advantage of wheel-positioning mechanism, volume of space available within a load-handling device, and other factors, as will be described in detail in the following detailed description. Optional features are set out in the dependent claims.

### BRIEF DESCRIPTION OF THE DRAWINGS

The tote-handling apparatus will now be described in detail with reference to examples, in which:

FIG. 1 schematically illustrates a storage grid;

FIG. 2 schematically illustrates a load-handling device;

FIG. 3 schematically illustrates a load-handling device;

FIG. 4 schematically illustrates a load-handling device;

FIG. 5 schematically illustrates a wheel-positioning mechanism for a load-handling device;

FIG. 6 schematically illustrates a wheel-positioning mechanism for a load-handling device;

FIG. 7 schematically illustrates a wheel-positioning mechanism for a load-handling device; and

FIG. 8 schematically illustrates a wheel-positioning mechanism for a load-handling device.

### DETAILED DESCRIPTION

The present embodiments represent preferred examples of how to implement aspects of load-handling devices, but they are not necessarily the only examples of how such aspects could be implemented.

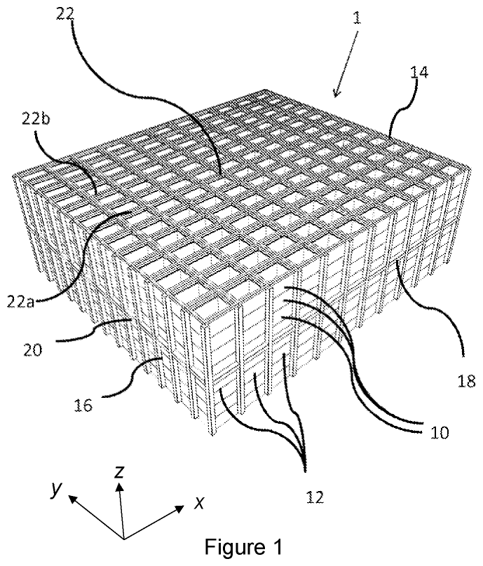

FIG. 1 illustrates a storage system comprising a storage grid 1. The storage grid 1 includes a plurality of rails or tracks 22 arranged in a grid pattern above stacks 12 of containers 10. The containers 10 may each contain or more items which are stored in the storage grid 1 until such time as the items are required, e.g. until such time as an order has been placed for one of the items in the containers 10. Alternatively, one or more of the containers 10 in the storage grid 1 may be empty and ready to receive one or more items.

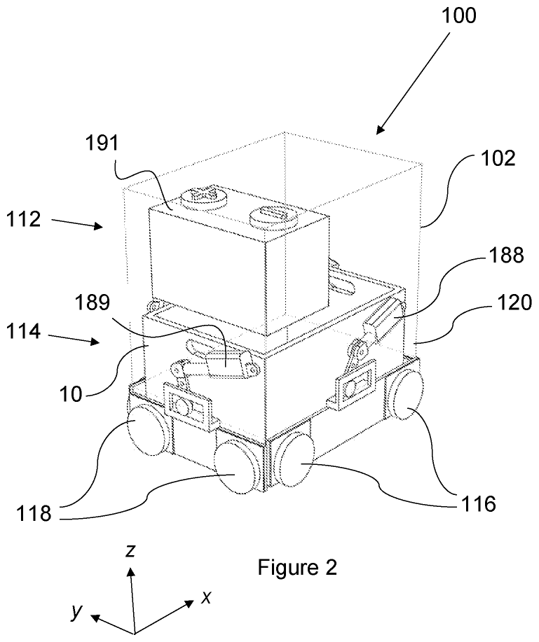

The grid pattern of storage grid 1 comprises a plurality of grid spaces, each stack 12 of containers 10 being located within a footprint of a single grid space. A plurality of load-handling devices 100 (“robots” or “bots”), such as the load-handling device 100 illustrated in FIG. 2, are configured to move laterally on the rails or tracks 22 above the stacks 12 and to go to grid spaces above any given stacks 12 of containers 10 and retrieve one or more containers 10 from the stacks 12. In the illustrated example, each bot 100 occupies only a single grid space on top of the storage grid 1. In other examples, a bot may occupy multiple grid spaces.

As illustrated in FIG. 2, a bot 100 comprises a body 102 having an upper portion 112 and a lower portion 114.

The upper portion 112 is configured to at least partially house one or more operation components. Possible examples of operation components which may be housed in the upper portion 112 include: one or more power components, such as a battery 191, configured to provide power to one or more other components of the bot 100; one or more control components configured to control one or more other components of the bot 100; one or more drive components configured to cause the bot 100 to be driven along the tracks 22 of a storage grid 1; and one or more container-lifting mechanisms configured to lift a container 10 from a stack 12. In the illustrated example, only battery 191 is shown, for simplicity.

The lower portion 114 is arranged beneath the upper portion 112. The lower portion 114 comprises a container-receiving space 120 or cavity 120 for accommodating a container 10. The container-lifting mechanism mentioned above may be configured to lift one or more containers 10 from a stack 12 of containers 10 in the storage grid 1 into the container-receiving space 120, and to lower one or more containers 10 out of the container-receiving space 120, e.g. onto a different stack 12 of containers 10, onto the same stack 12 of containers 10, or to a different location, such as a picking station where items can be placed into or taken out of the one or more containers 10, or an egress point of the storage grid 1 (i.e. a point at which containers 10 may leave the storage grid 1). The container-lifting mechanism may for example comprise container-engaging means configured to grip or otherwise engage and hold the one or more containers, and one or more motors or other lifting means configured to raise and lower the container-engaging means and any container(s) engaged by the container-engaging means into and out of the container-receiving space 120. The container-engaging means may be referred to as container-gripping means or a gripper. The container-lifting mechanism may be at least partially housed in the lower portion 114 of the body 102 when the container-lifting mechanism is in a retracted position.

A wheel assembly configured to enable the bot 100 to engage with the rails or tracks 22 of the storage grid 1 illustrated in FIG. 1 is connected to the body 102 of the bot 100 in the lower portion 114 of the body 102. The rails or tracks 22 of the storage grid 1 comprise a first set of rails or tracks 22a which extend in a first direction (along or substantially parallel to the x-axis illustrated in FIG. 1), and a second set of rails or tracks 22b which extend in a second direction (along or substantially parallel to the y-axis illustrated in FIG. 1). In the illustrated example, the second direction is substantially orthogonal to the first direction (i.e. the rails 22a are at approximately 90° to the rails 22b), but in other examples the angle or angles between the two sets of rails may be different. The wheel assembly comprises a first set of wheels 116 configured to be engageable with tracks 22a in the first set of rails or tracks 22a, to guide movement of the bot 100 in the first direction, and a second set of wheels 118 configured to be engageable with tracks 22b in the second set of rails or tracks 22b, to guide movement of the bot 100 in the second direction.

The illustrated first set of wheels 116 includes a total of four wheels: two wheels positioned on a first side of the bot 100 (e.g. the longer side illustrated towards the right-hand side in FIG. 2) and two wheels positioned on a third side of the bot 100 which is opposite the first side (third side of the bot not properly visible in FIG. 2). Similarly, the illustrated second set of wheels 118 includes a total of four wheels: two wheels positioned on a second side of the bot 100 (e.g. the shorter side illustrated towards the left-hand side in FIG. 2) and two wheels positioned on a fourth side of the bot 100 which is opposite the second side (fourth side of the bot not properly visible in FIG. 2). In other embodiments, a different number of wheels may be provided in the first set and/or the second set. For example, it may be advantageous in some embodiments to have three or four wheels on one or more sides of the bot 100.

A wheel-positioning mechanism is provided in the lower portion 114 of the body 102. The wheel-positioning mechanism comprises wheel-engaging means for selectively engaging either the first set of wheels 116 with tracks 22a in the first set of rails or tracks 22a, to enable the bot 100 to move in the first direction, or the second set of wheels 118 with tracks 22b in the second set of rails or tracks 22b, to enable the bot to move in the second direction. The wheel-engaging means comprises moving means which, in the embodiment illustrated in FIG. 2, takes the form of linear actuators which are configured to apply raising or lowering forces to respective pairs of wheels.

In the example illustrated in FIG. 2, a first linear actuator 188 is pivotably mounted on the longer visible side of the bot 100 (referred to as the first side) and is indirectly connected to the pair of wheels 116 on that first side of the bot 100. The two wheels labelled 116 in FIG. 2 constitute two of the four wheels in the first set of wheels 116.

The first linear actuator 188 causes the illustrated pair of wheels 116 to be raised or lowered, relative to the body 102 of the bot 100, causing the pair of wheels 116 to be lifted away from or lowered towards a track 22a in the first set of tracks 22a. A corresponding third linear actuator (not fully visible in FIG. 2) is pivotably mounted on the opposite longer side of the bot 100 (referred to as the third side) and is indirectly connected to the pair of wheels on that third side of the bot 100. The two wheels on the third side of the bot 100 constitute the other two of the four wheels in the first set of wheels 116. The third linear actuator causes the corresponding pair of wheels to be raised or lowered, relative to the body 102 of the bot 100, causing the pair of wheels to be lifted away from or lowered towards a track 22a in the first set of tracks 22a.

Analogously, a second linear actuator 189 is pivotably mounted on the shorter visible side of the bot 100 in FIG. 2 (referred to as the second side) and is indirectly connected to the pair of wheels 118 on that second side of the bot 100. The two wheels 118 on the second side of the bot 100 constitute two of the four wheels in the second set of wheels 118. The second linear actuator 189 causes the illustrated pair of wheels 118 to be raised or lowered, relative to the body 102 of the bot 100, causing the pair of wheels 118 to be lifted away from or lowered towards a track 22b in the second set of tracks 22b. A corresponding fourth linear actuator (not fully visible in FIG. 2) is pivotably mounted on the opposite shorter side of the bot 100 (referred to as the fourth side) and is indirectly connected to the pair of wheels on that fourth side of the bot 100. The two wheels on the fourth side of the bot 100 constitute the other two of the four wheels in the second set of wheels 118. The fourth linear actuator causes the corresponding pair of wheels to be raised or lowered, relative to the body 102 of the bot 100, causing the pair of wheels to be lifted away from or lowered towards a track 22b in the second set of tracks 22b.

The four linear actuators may be independently controllable but are generally controlled such that the first linear actuator 188 and the third linear actuator raise or lower their respective wheels 116 at substantially the same time as each other, and such that the second linear actuator 189 and the fourth linear actuator raise or lower their respective wheels 118 at substantially the same time as each other. This allows either all four wheels in the first set of wheels 116 to be in contact with tracks in the first set of tracks 22a or all four wheels in the second set of wheels 118 to be in contact with tracks in the second set of tracks 22b at once, enabling the bot 100 to selectively move in either the first (x) direction or the second (y) direction across the grid.

Advantageously, this configuration of four linear actuators configured to raise and/or lower their respective pairs of wheels 116, 118 relative to the body 102 of the bot 100 allows movement of the centre of mass of the bot 100 to be minimised when the bot 100 changes direction of movement (i.e. changes from being configured for movement along the first set of tracks 22a in the first direction to being configured for movement along the second set of tracks 22b in the second direction, or vice versa). For example, if the bot 100 is moving in the first direction along the first set of tracks 22a, the first set of wheels 116 (indirectly connected to the first and third linear actuators) will be kept in the lowered configuration, such that the first set of wheels 116 is in contact with tracks 22a in the first set of tracks 22a, and the second set of wheels 118 (indirectly connected to the second and fourth linear actuators) will be kept in the raised configuration, such that the second set of wheels 118 is not in contact with tracks 22b in the second set of tracks 22b.

When the bot 100 reaches a junction on the grid 1 and needs to change its direction of travel, the second and fourth linear actuators may cause the second set of wheels 118 to be lowered, such that the second set of wheels 118 comes into contact with tracks 22b in the second set of tracks 22b. That will involve little-to-no movement of the centre of mass of the bot 100, since the majority of the mass of the bot 100 (including any container 10 and container-contents currently within the vehicle's container-receiving space 120) remains stationary in the z direction, supported by the first set of wheels 116. When the second set of wheels 118 is in contact with the tracks 22b, the first and third linear actuators may cause the first set of wheels 116 to be raised, such that the first set of wheels 116 is no longer in contact with tracks 22a in the first set of tracks 22a. That too will involve little-to-no movement of the centre of mass of the bot 100, since the majority of the mass of the bot 100 (including any container 10 and container-contents) remains stationary, supported by the second set of wheels 118. The bot 100 may then proceed in the second direction along the tracks 22b in the second set of tracks 22b. If bot 100 needs to change direction again, the second set of wheels 118 may be kept in contact with tracks 22b while the first and third actuators lower the first set of wheels 116 into contact with tracks 22a. When the first set of wheels 116 is in contact with tracks 22a, the second and fourth actuators raise the second set of wheels 118 off tracks 22b, such that the weight of the bot 100 is supported by the first set of wheels 116 only, and the bot 100 can move in the first direction along the tracks 22a. Throughout the process of raising and lowering the sets of wheels 116, 118 using the first, second, third and fourth actuators, movement of the centre of mass of the bot 100 is minimised.

Minimising movement of the centre of mass of the bot 100 may have numerous advantages, including: minimised wear on the tracks 22a, 22b and other components of the grid 1, since the change in force on the grid 1 due to the acceleration of the mass of the bot 100 is minimised; minimised vibration of the grid 1 and corresponding noise and disruption when the bot 100 changes direction; minimised wear on the components of the bot 100, since the forces applied to the components when the bot 100 changes direction are minimised; and minimised force requirement for the linear actuators relative to arrangements in which only one set of wheels 116 or 118 is configured to be raised or lowered relative to the body of the bot 100 (in such embodiments, the entire weight of the bot 100 needs to be lifted when the one set of wheels is lowered, whereas in the configurations of this document, only the weight of the wheels and the components on which they are mounted need to be lifted)—this may allow a lighter, faster and/or lower-cost wheel-engaging means (linear actuator, in the illustrated example) to be used than in alternative arrangements.

Minimising movement of the centre of mass of the vehicle may furthermore lead to a substantially constant height of the bot 100 during use. This may advantageously mean that any connectors or other components which are mounted on the bot 100 and which need to connect to or interact with a corresponding connector or other component which is mounted externally to the bot 100, e.g. above the storage grid 1 or at an edge of the storage grid 1, should be more reliably able to connect to or interact with the corresponding connector/component, without adjustment of the bot 100 and/or the external connector or other component. This may enable routine operations, such as charging of the bot 100 at a charging station located at a periphery of the storage grid 1, to be conducted more efficiently and with less external input than in embodiments of bot in which the centre of mass of the bot is moved significantly up and down to allow the bot to change direction (in those cases, the charging equipment and/or a bot may need to be raised or lowered to enable the bot to engage with the charging equipment).

In some examples, one set of wheels 116, 118 may be lowered at substantially the same time that the other set is raised, which may lead to greater movement of the centre of mass of the bot 100 but may advantageously reduce the time required for changing direction of movement of the bot 100.

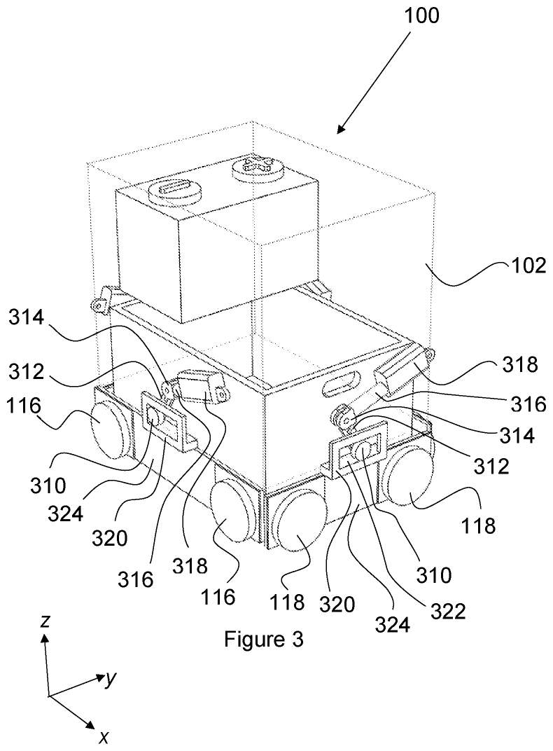

Components of two of the four linear actuators and the components that connect those two linear actuators to their respective pairs of wheels 116, 118 are labelled in FIG. 3. The same reference numerals have been used to denote the common features of the two illustrated linear actuators and connecting components. In the illustrated example, the two labelled linear actuators are identical to one another and to the not-fully-illustrated linear actuators on the other two sides of the bot 100. The following description therefore applies equally to all four of the linear actuators. In other examples, the linear actuators may be different from one another. In some examples, one or more of the four linear actuators on the four sides of a bot may be replaced by a different type of moving and/or wheel-engaging means, such as a rotary motor, a pneumatic or hydraulic piston, or an alternative arrangement. In other embodiments, only two engaging and moving means (e.g. linear actuators) may be provided, e.g. on the first and third or second and fourth sides of the bot. In such a case, the weight of the bot may be raised or lowered as one set of wheels is taken out of contact with respective tracks and the other set of wheels is brought into contact with the respective tracks.

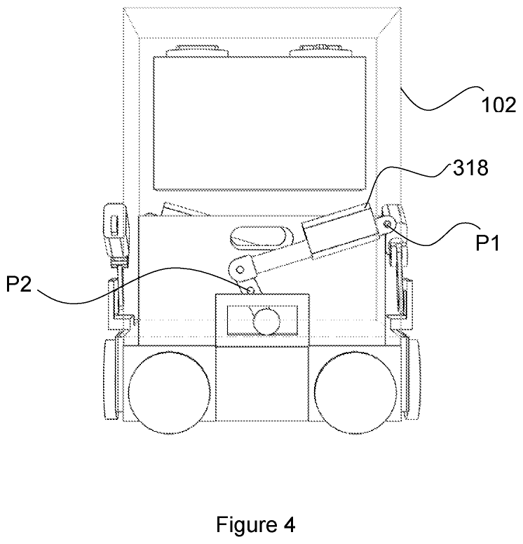

Each linear actuator comprises a housing 318 which is pivotably attached to the body 102 of the bot 100 at a respective first pivot point P1 (see FIG. 4). An extending and retracting member 316 of the linear actuator is movably connected to the housing 318. The extending/retracting member 316 can be moved further into or further out of the housing 318 by a corresponding motor or other movement means, which may for example be located within the housing 318. The extending/retracting member 316 is pivotably connected via a pivoting connector 314 to a first end of a linkage 312. The linkage 312 is pivotably attached to the body 102 of the bot 100 at a respective second pivot point P2 (see FIG. 4). A roller 310 is rotatably connected to a second end of the linkage 312. A frame 320 is attached to a panel 324 on which the two wheels 116 or 118 are rotatably mounted. The frame 320 includes an aperture 322 or recess 322 within which the roller 310 can roll. The two pivot points P1 and P2 and the frame 320 constrain the range of movements that the housing 318, the extending/retracting member 316, the pivoting connector 314, the linkage 312 and the roller 310 can undergo.

The movement of one linear actuator and its associated components from a fully retracted (wheels lowered) configuration to a fully extended (wheels raised) configuration will now be described with reference to the illustrated example. When the linear actuator is in the fully retracted configuration, the extending/retracting member 316 is at its most-retracted position into the housing 318 (see the extending/retracting member 316 of the linear actuator on the longer side of the bot, towards the left-hand side of FIG. 3; some of the extending/retracting member 316 may still be outside the housing 318 in the fully retracted configuration). The pivoting connector 314 is therefore at its closest to the housing 318. The linkage 312 is pivoted about the second pivot P2 such that the first end of the linkage 312 is to the right of the second pivot P2 (as viewed in the figure). The second end of the linkage is to the left of the second pivot P2. The roller 310 too is therefore to the left of the second pivot P2, and applies a downward pushing force to the lower surface of the aperture 322 in frame 320. This downward pushing force is applied by the frame 320 to the panel 324 on which the wheels are mounted. The wheels are therefore held in their downwards configuration when the linear actuator is in its fully retracted configuration. The bot 100 may include one or more braking, latching or stopping means to constrain movement of the extending/retracting member 316 away from the fully retracted position or the fully extended position. For example, a brake and/or an end stop may be provided inside the housing 318 to help constrain movement of the extending/retracting member 316 beyond an intended fully retracted position and/or towards an extended configuration when the extending/retracting member 316 is in the retracted configuration. This may help to prevent damage to the housing 318, the extending/retracting member 316, the components which are connected to the linear actuator, and/or to other components of the bot 100 or the storage grid 1, since it may help reduce the risk of the supporting wheels of the bot 100 unexpectedly moving from the lowered configuration to the raised configuration, thus reducing the risk of a sudden collapse of the bot 100 onto the grid 1.

To move the wheels from the lowered to the raised configuration, the linear actuator drives the extending/retracting member 316 further out of the housing 318, towards the position that the extending/retracting member 316 on the shorter visible side of the bot in FIG. 3 (illustrated towards the right-hand side of the figure) is in. The movement of the pivoting connector 314 is constrained by the pivoting connector 314's connection to the linkage 312 and the linkage 312's constraint to move about the second pivot P2. The pivoting connector 314 is therefore moved through an arc, about second pivot P2, finishing to the left of and lower than its initial position. To accommodate this arcing of the pivoting connector 314 (to which the extending/retracting member 316 is connected or which is a part of the extending/retracting member 316), the housing 318 pivots about first pivot P1, first clockwise as the pivoting connector 314 is moved on the upward curve of the arc, then anticlockwise as the pivoting connector 314 moves on the downward curve of the arc. The first end of the linkage 312 (to which the pivoting connector 314 is attached) moves through a corresponding arc, under the constraint of pivot point P2. The second end of the linkage 312 moves correspondingly around the pivot point P2, finishing to the right of and higher than its initial position. The roller 310 moves correspondingly, finishing to the right of and higher than its initial position. This movement of the roller 310 to the right and upwards causes the roller 310 to apply a lifting force to the upper face of the aperture 322, which causes the frame 320 to be raised relative to the body 102 of the bot 100. The frame 320, which is connected to the panel on which the wheels 116, 118 are mounted, causes the panel and the wheels 116, 118 to be raised relative to the body 102 of the bot 100. This allows the wheels 116, 118 corresponding to the specific linear actuator to be lifted off their respective tracks 22a, 22b. When the wheels 116, 118 have been lifted off their respective tracks 22a, 22b, the other wheels 118, 116 may be left in contact with their respective tracks 22b, 22a, to enable the bot 100 to move in a different direction from before. The linear actuator may extend the extending/retracting member 316 out of the housing 318 until the corresponding wheels have been raised a predetermined distance relative to the body 102 of the bot 100, until a predetermined gap between the corresponding wheels 116, 118 and the corresponding tracks 22a, 22b has been achieved, or until another criterion or threshold has been met. A minimum elevation of the wheels 116, 118 above their respective tracks 22a, 22b may for instance be determined in dependence upon an expected variation in the height of the bot 100 as the bot 100 moves along tracks 22a, 22b, e.g. due to bending of the wheel assembly as the bot 100 travels and/or due to imperfections in the tracks 22a, 22b, or other factors.

The angle of the illustrated linkage 312 when the linear actuator is in the fully retracted position has been exaggerated for illustrative purposes. The angle of the linkage 312 clockwise past the vertical (as looked at from the outside of the bot, as in the figures) when the linear actuator is in the fully retracted position may be very small or zero. For example, the angle of the linkage 312 clockwise past the vertical may be between 0° and 5° or, more preferably, between 0° and 1°. It may be advantageous for the angle to be greater than zero, as this may enable an “over centre” locking facility to be provided for the linkage 312 and the connected components. In particular, allowing the roller 310 and linkage 312 to move past the vertical may mean that the roller 310 and the linkage 312 are moved past an unstable “balance point”, from which the roller 310 and linkage 312 could move independently (thus allowing an unexpected raising or lowering of the corresponding wheels), to a stable over-centre position which the roller 310 and linkage 312 would need to be moved away from (e.g. by the driving means of the linear actuator). This may help minimise the risk that the wheels will unexpectedly move out of the lowered position, for example. This may help to avoid the body 102 of the bot 100 collapsing onto the grid 1. It may also help minimise the force that is required of the linear actuator to hold the wheels in the lowered configuration.

In alternative examples, it may be advantageous for the angle of the linkage 312 relative to the vertical to be zero when the linear actuator and associated components are in the “wheels lowered” configuration, as this may enable a faster and/or lower-energy transition between the “wheels lowered” configuration and the “wheels raised” configuration, since the “wheels lowered” configuration may correspond to an arrangement involving an unstable “balance point” as discussed above, which it is easier to move the respective components away from than it is to move the components away from a stable “over centre” position.

The process of moving the wheels from the raised position (illustrated towards the right-hand side of FIG. 3) into the lowered position (illustrated towards the left-hand side of FIG. 3) is substantially similar but reversed. The linear actuator retracts the extending/retracting member 316 into the housing 318. The pivoting connector 314 follows the previously described arc in the opposite direction from before. The linkage 312 moves correspondingly about pivot point P2, causing the roller 310 to move downwards and to the left. The roller 310 comes into contact with the lower surface of the aperture 322 in frame 320, applying a downward force to the frame 320, which causes the panel 324 and the wheels mounted thereon to be lowered relative to the body 102 of the bot 100. This allows the wheels to be brought into contact with tracks of the storage grid 1.

Having four such linear actuators therefore provides means to facilitate a transition of the bot between an “x” configuration (i.e. a configuration in which the bot can travel along or parallel to the x-axis illustrated in FIG. 1) and a “y” configuration (i.e. a configuration in which the bot can travel along or parallel to the y-axis illustrated in FIG. 1), by allowing different pairs of wheels to be engaged with corresponding tracks as required.

Although in the illustrated embodiment each linear actuator is pivotably mounted towards the right-hand end of one side of the bot, in other embodiments the illustrated linear actuator and connecting components may be mounted elsewhere. For example, they may be mounted the opposite way round from the illustrated linear actuators and components, i.e. mirrored about a central line of each side of the bot, so that the linear actuator is pivotably mounted towards the left-hand side instead, or otherwise arranged.

As described above, the raising of one set of wheels 116, 118 may be conducted shortly after, or during, the lowering of the other set of wheels 118, 116, to allow the bot 100 to move in different directions along corresponding tracks 22a, 22b.

Advantageously, the illustrated arrangement including a roller 310 which can roll between contacting the lower surface of an aperture 322 in a frame 320 and contacting the upper surface of the aperture 322 provides a smooth application of force to raise and lower the wheels. This may help to minimise a change in force experienced by the wheels 116, 118 and/or the tracks 22a, 22b of the storage grid 1 as the wheels 116, 118 are brought into contact with the tracks 22a, 22b. The arrangement may advantageously extend the period of time over which the weight of the bot 1 on the grid 1 is added to the wheels, minimising shocks to the grid 1 and/or the bot 100. This may help reduce noise and vibration generated by the changeover from one set of wheels 116, 118 to the other set of wheels 118, 116, as well as minimising damage to the components of the bot 100 and the grid 1.

In the illustrated examples, the aperture 322 in the frame 320 is substantially rectangular in profile. In other examples, the aperture 322 may have a different shape. For instance, the aperture 322 may be shaped to achieve a particular lifting trajectory or lifting speed of the frame 320, the panel 324 and the corresponding wheels. For example, it may be desirable for a small angle of rotation of the linkage 312 to correspond to a large degree of lifting of the frame 320 and connected components as the linkage 312 is first moved away from the vertical, and for the rate of lifting to slow down as the linkage 312 is moved further away from the vertical. In other examples, the reverse may be preferable, i.e. for a small angle of rotation of the linkage 312 to correspond to a small degree of lifting of the frame 320 and connected components as the linkage 312 is first moved away from the vertical, and for the rate of lifting to increase as the linkage 312 is moved further away from the vertical. The aperture may be shaped to provide one or more “over centre” positions, as described above, which the linkage 312 and roller 310 are less likely to be able to move away from inadvertently, i.e. which require a positive force to be applied by the driving means of the linear actuator to cause the roller 310 to move away from, rather than being “balance points” that the roller 310 could roll away from unless constrained.

As mentioned above, one or more end stops, braking means or latches may be provided to help constrain movement of the extending/retracting member 316 and/or other components beyond or away from certain positions. For example, in embodiments in which the linkage 312 is intended not to go past 0° to the vertical (or to go only a small angle past 0° to the vertical) in the “wheels lowered” configuration, one or more end stops may be provided to constrain movement of the linkage 312 up to or slightly past the 0° angle. The end stop(s) may be provided in any of various positions. For example, the end stop(s) may be provided on the frame 320 to stop movement of the roller 310 past a position corresponding to a substantially vertical orientation of the linkage 312 (i.e. the 0° angle). In some embodiments, the upright end section of the frame 320 may constitute the end stop, i.e. the frame 320 and/or other components connected to the linkage 312 may be dimensioned and arranged such that the roller 310 cannot roll past a position corresponding to a substantially vertical orientation of the linkage 312, because the roller 310 reaches the upright end section of the frame 320. Alternatively or additionally, an end stop may be provided on or within the housing 318 of the linear actuator, to prevent the extending/retracting member 316 from withdrawing into the housing 318 sufficiently far to draw the linkage 312 past a substantially vertical orientation. There may be a feature on the extending/retracting member 316 which is sized and positioned to engage with a corresponding feature or surface of the housing 318 to limit the retraction of the extending/retracting member 316 into the housing 318. Alternatively or additionally, an end stop in the form of a rotation stop may be provided, e.g. on the component of the bot 100 on which the linear actuator is mounted, to stop the linkage 312 rotating past the substantially vertical orientation. The rotation stop may be positioned adjacent to the linkage 312 and be positioned such that the linkage 312 comes into contact with the rotation stop when the linkage 312 has rotated to the intended farthest position. Alternatively or additionally, a rotation stop may be positioned adjacent to the extending/retracting member 316, the pivoting connector 314 and/or the housing 318, and may be positioned such that the extending/retracting member 316, the pivoting connector 314 and/or the housing 318 comes into contact with the rotation stop when the extending/retracting member 316, the pivoting connector 314 and/or the housing 318 has rotated to the intended farthest position. A rotation stop may alternatively or additionally be located on the linkage 312, the pivoting connector 314 and/or the extending/retracting member 316 to constrain the range of relative angles that the linkage 312 and the extending/retracting member 316 can occupy. In some embodiments, at least two rotation stops may be provided. One rotation stop may for example limit the movement of the components beyond the intended “wheels lowered” configuration, and another rotation stop may for example limit the movement of the components beyond the intended “wheels raised” configuration.

Although in the above description the example is given of constraining the linkage 312 not to go past a substantially vertical orientation when moving into the “wheels lowered” configuration, the end stop(s) could be arranged to provide any desired constraint to the movement of the linear actuator and/or and its connected components. For example, the end stop(s) may alternatively or additionally constrain the linkage 312 not to rotate beyond an orientation corresponding to the “wheels raised” configuration, i.e. a specific angle corresponding to an intended extent of lifting of the corresponding wheels. This may advantageously help to minimise the work done by the linear actuator in raising the wheels, by helping ensuring that the wheels are not lifted further than necessary to enable the bot 100 to move in a transverse direction.

Advantageously, such an end stop or end stops may help to minimise a force which needs to be borne by a specific component of the wheel-positioning mechanism, such as the driving means of the linear actuator, due to the weight of the bot 100 or the weight of the panel 324 and wheels 116, 118 to which the linkage 312 in question is connected, for example. The force or a component thereof may instead be at least partially borne by the end stop or a combination of corresponding end stops (e.g. on opposite sides of the bot 100). This may help extend the expected lifetime of the linear actuator, since the force will be borne at least in part by the end stop features rather than solely by the driving means of the linear actuators on the bot 100.

Alternatively or additionally to the above-described end stop(s), braking means may be provided, e.g. on or within the linear actuator. The braking means may serve an analogous purpose to the above-described end stop(s). For example, the braking means may help minimise the force which needs to be borne by the driving means of the linear actuator. The braking means may take the form of clamping means which is configured to clamp the extending/retracting member 316 to limit the retraction of the extending/retracting member 316 into or the extension of the extending/retracting member 316 out of the housing 318 and to hold the extending/retracting member 316 in a given position relative to the housing 318. The braking means may for example clamp the extending/retracting member 316 such that the linkage 312 remains in the substantially vertical configuration (i.e. at 0° to the vertical). This may help to ensure that the corresponding wheels are not unexpectedly moved from the lowered configuration to the raised configuration or vice versa. The braking means may be a powered electromechanical component forming part of the linear actuator and controllable as part of the linear actuator, or a separate component controllable separately from the linear actuator.

The end stop and/or the braking means may therefore help support at least some of the weight of the bot 100 when the corresponding linear actuator is in the retracted (wheels lowered) configuration, i.e. the configuration in which the wheels corresponding to the given linear actuator are lowered, in contact with tracks 22a, 22b on storage grid 1, and/or at least some of the weight of the wheels 116, 118 and corresponding panel 324 when the corresponding linear actuator is in the extended (wheels raised) configuration, i.e. the configuration in which the wheels corresponding to the given linear actuator are raised and not in contact with tracks 22a, 22b on storage grid 1. Preferably, each of the linear actuators includes a similar or identical end stop and/or braking means feature, each of the end stop and/or braking means features of the four linear actuators being configured to support at least some of the weight of the bot 100 when the corresponding linear actuators are in the retracted (wheels lowered) configuration and/or at least some of the weight of the respective panel 324 and wheels when the corresponding linear actuators are in the extended (wheels raised) configuration. Thus the end stop and/or brake features may help hold up the weight of the bot when the driving means of the linear actuator is not engaged to apply a driving force to the extending/retracting member 316, and/or may help hold up the weight of the wheels and the panels on which the wheels are mounted when the driving means of the linear actuator has applied a driving force to the extending/retracting member 316 to extend the extending/retracting member 316 out of the corresponding housing 318.

Latching means may be provided in addition or as an alternative to the above-described braking means and/or the above-described end stop(s). The latching means may serve to constrain the movement of the wheels into or, especially, out of a given position. As a first example, latching means may be provided in the form of a magnetic latching mechanism comprising two magnets, one mounted on the linkage 312 or the roller 320 and one mounted on the frame 324, for instance, which are attracted to one another and serve to hold one another and their respective components substantially together, up to a given separation force. As a second example, latching means in the form of a mechanical roller latch may be provided, such as a plunger ball roller (i.e. a ball mounted in a recess with a retracting function to enable the ball to be pushed into the recess and out of the way of a component such as the roller 310) or another suitable feature or mechanism. The latching means provides resistance to movement of the roller 310 or another of the components connecting a linear actuator and the corresponding wheels 116, 118. A roller latch may for example be provided in the aperture 322 of the frame 320 such that the roller 310 is moved by its corresponding linear actuator over the roller latch (depressing the roller latch into its recess) as the roller 310 moves into the “wheels raised” configuration and is constrained from moving back over the roller latch unless a sufficient force is applied to the roller 310 (i.e. by the linear actuator) to overcome the roller latch and allow the roller 310 to move to the “wheels lowered” configuration. The latch may therefore help hold the wheels in the “wheels raised” configuration. An alternative or additional roller latch may be provided at an appropriate position such that the roller 310 is moved by the roller 310's corresponding linear actuator over the alternative or additional roller latch as the roller 310 moves into the “wheels lowered” configuration and is constrained from moving back over the alternative or additional roller latch unless a sufficient force is applied to the roller 310 (i.e. by the linear actuator) to overcome the alternative or additional roller latch and allow the roller 310 to move to the “wheels raised” configuration. Overcoming a roller latch may for example involve displacing a sprung or biased component of the roller latch out of the way of the intended direction of movement of the roller 310. The level of spring or bias of the roller latch may be chosen to provide a resistance corresponding to forces which the roller 310 is likely to experience as a consequence of the weight of the panel and wheels that the roller 310 is responsible for raising and lowering, to the weight of the bot 100, and/or to the forces that the corresponding linear actuator is capable of exerting on the roller 310.

As discussed above, the illustrated arrangement of linear actuators configured to raise and lower the respective pairs of wheels 116, 118 relative to the body 102 of the bot 100 may advantageously need less power than, for example, an arrangement in which substantially the entire weight of the bot is lifted and held up to facilitate a change of direction of movement of the bot 100 (e.g. where the bot can move in one direction on a first set of immovable wheels when the body of the bot is in a relatively lowered configuration and in another direction on a second set of moveable wheels when the body of the bot is in a relatively raised configuration due to the second set of wheels having been moved downwards, relative to the body of the bot, to bring the second set of wheels into contact with a movement surface and to move the first set of wheels out of contact with the movement surface). In particular, in arrangements where the illustrated linkage 312 is moved to a substantially vertical orientation when the wheels 116, 118 are moved to the lowered configuration, the corresponding linear actuators may not need to support or lift more than the weight of the wheels 116, 118 and the components on which the wheels 116, 118 are mounted. The linear actuators may in particular not need to lift the weight of the bot 100. This arrangement of the components may advantageously reduce the performance requirements for the linear actuator, which may lower the cost of producing the bot and/or the cost of running the bot (since the linear actuator may consume less power in conducting its raising and lowering strokes than a linear actuator which is required to lift the whole weight of the bot). In embodiments in which linear actuators on adjacent sides of the bot 100 are arranged to raise and lower their respective wheels substantially simultaneously (e.g. in which the first and second linear actuators 188, 189 are arranged to raise and lower their respective wheels 116, 118 at substantially the same time, and/or vice versa), the linear actuators may need to lift the weight of the bot 100, but may not need to lift the weight through as great a distance as in embodiments with only a single set of moveable wheels.

Advantageously, the illustrated configuration of wheel-positioning mechanism comprising a linear actuator and connected components located at substantially the exterior of the bot 100 and in the lower portion 114 of the bot 100 may be relatively easy to install and remove, e.g. during construction, servicing or dismantling of the bot. The illustrated wheel-positioning mechanism may provide a relatively “quick release” wheel-positioning mechanism which can be quickly removed from the bot 100, and/or a relatively “modular” wheel-positioning mechanism which can be swapped for a replacement module if necessary. This may be particularly the case in comparison to bots which have wheel-positioning mechanisms located at least partially in an upper portion of the bot and which therefore include longer components which extend through more of the bot in order to reach the wheels. Such configurations may require more parts of the bot to be removed before the wheel-positioning mechanism is sufficiently exposed for components to be removed or changed. Furthermore, the illustrated wheel-positioning mechanism may make it easier to access other components housed within the body 102 of the bot 100, e.g. by allowing unobstructed access to the other components housed within the body 102 of the bot 100 by virtue of the location of the wheel-positioning mechanism in the lower portion 114 of the bot 100.

The illustrated configuration may also advantageously consume relatively little space in the bot 100. The configuration may for example have a depth (dimension into the bot, e.g. in the y-direction for first linear actuator 188 or the x-direction for the second linear actuator 189) of less than 50 mm. The configuration may more particularly have a depth of between 40 mm and 45 mm and, in particular embodiments, a depth of 44 mm. The configuration may additionally have a relatively narrow width (dimension along the respective side of the bot, e.g. in the x-direction for the first linear actuator 188 or the y-direction for the second linear actuator 189) and/or a relatively low height (dimension up the respective side of the bot, in the z-direction for any of the linear actuators). The illustrated wheel-positioning mechanism may therefore be a relatively compact example of a wheel-positioning mechanism for raising and lowering wheels 116, 118 relative to the body 102 of a bot 100. This may advantageously mean that there is more room within the body 102 of the bot 100 for the container-receiving space 120 and/or for other components of the bot 100, such as for larger power components 191 and/or larger versions of other types of component which may be housed within the body 102 of the bot 100, e.g. in the upper portion 112, such as control components, drive components and/or container-lifting components. This may enable the bot to perform other aspects of its work (such as raising or lowering a container 10, or moving along the tracks 22a, 22b) more rapidly than bots with less space for the corresponding components. It may furthermore simplify maintenance of the bot 100, since the relatively low-depth, low-width and/or low-height wheel-positioning mechanism may obstruct fewer other components of the bot 100 than alternative wheel-positioning mechanisms.

Although in the illustrated configurations the linear actuators and other components of the wheel-positioning mechanism are visible, one or more covering panels may be provided on the exterior of a bot to obscure from view and protect the components. The covering panels may be arranged to be easily removed and replaced, e.g. to allow maintenance or replacement of parts within the bot 100. In other embodiments, the linear actuators and/or other components may be mounted on an external panel of the bot 100. In such embodiments, the linear actuators and/or other components may be visible during normal use of the bot 100. The linear actuators and other components of the wheel-positioning mechanism need not necessarily be provided internally to the body 102 of the bot 100 (i.e. inside the space defined by the body 102). They may instead be provided outside the body 102 of the bot 100, e.g. mounted on the outer surface of the body 102, but may be protected by a cladding or other protective layer.

The upper portion 112 and the lower portion 114 of the body 102 of the bot 100 are not necessarily bounded by the body 102 of the bot 100—they may for example include space around the outside of the body 102, such that components connected to the outside of the body 102 (such as a wheel assembly or a wheel-positioning mechanism) can be regarded as being in the upper or lower portion 112, 114.

The body 102 of the bot 100 may include four shafts extending substantially in the z-direction, one in the vicinity of each corner of the body 102, which the panels 324 may be slidably attached to. For example, each panel 324 may include two sliding bearing apertures or holes, one at each end of the panel 324, which are sized and positioned to receive corresponding corner shafts. In such a configuration, two of the four panels 324 of the bot 100 will be attached to each shaft. The panels 324 may each slide up and down the shafts as the linear actuators 188, 189 cause the panels 324 to be raised or lowered (i.e. to move in the z-direction). The bearing apertures or holes that receive the shafts may be positioned on complementarily positioned and shaped portions of the panels 324. For example, each panel 324 may include a first reduced-z-dimension portion at a lower-left position at one end of the panel 324 and a second reduced-z-dimension portion at an upper-right position at the other end of the panel 324, each reduced-z-dimension (or “reduced-height”) portion including the respective bearing aperture or hole for that end of the panel 324. The two reduced-z-dimension portions may allow corresponding reduced-z-dimension portions of neighbouring panels 324 to receive and be slidable up and down the same shafts. This may advantageously reduce the space required for and the weight of the wheel-positioning mechanism and associated components, since there may be only a single shaft in each corner of the bot 100 for guiding the panels 324 up and down relative to the rest of the body 102 of the bot 100, and the weights of the panels 324 may be reduced due to the reduced-z-dimension portions at the ends of the panels 324.

Alternatively or additionally, the body 102 of the bot 100 may include linear guides which are arranged to interact with corresponding linear guides mounted on or forming part of the respective panels 324 to allow the panels 324 to slide up and down. The linear guides may for example comprise dovetailing features (e.g. a protrusion on a panel linear guide and a recess on a body linear guide, or vice versa) to enable the panels 324 to slide up and down, guided by the linear guides.

The wheels 116, 118 are rotatably mounted on their respective panels 324 to allow the wheels 116, 118 to rotate about their respective rotation axes. This enables the bot 100 to move along tracks 22a, 22b. The panels are raised and lowered relative to the body 102 of the bot 100 rather than the wheels being raised and lowered relative to the panels. In other words, the wheel assembly includes a chassis comprising panels on which the wheels are rotatably but otherwise fixedly mounted. The respective panels of the wheel chassis are configured to move relative to the body 102 of the bot 100 to cause the wheels 116, 118 to move relative to the body 102. The illustrated configuration including such a chassis may advantageously mean that the wheels 116, 118 are less likely to splay, pivot or otherwise move out of the intended positioning or alignment to support the weight of the bot 100 and permit movement of the bot 100 along tracks 22a, 22b than alternative configurations of wheel assemblies in which the wheels are arranged to move up and down relative to the panels or other structure(s) on which they are mounted to effect the raising and lowering of the wheels onto and off the tracks 22a, 22b. This may mean that the wheels in the illustrated configuration are more robustly and/or stiffly mounted, providing greater rigidity for the bot 100. This may help to make the bot 100 more stable as it rests on and travels along the tracks 22a, 22b, and/or as it transitions from being configured to move in the first direction to being configured to move in the second direction.

Advantageously, the linear actuators and other components of the wheel-positioning mechanism for raising and lowering the wheels 116, 118 relative to the body 102 of the bot 100 may be positioned in the lower part 114 of the bot 100, as illustrated in FIG. 3. This may advantageously help to lower the centre of mass of the bot 100, helping to improve the stability of the bot. The wheel-positioning mechanism may advantageously be positioned adjacent to the container-receiving space 120 and substantially or completely below the top of the container-receiving space 120. Such positioning may particularly advantageously help to lower the centre of mass of the bot 100 when the container-receiving space 120 is empty or contains a container 10 which is empty or only lightly loaded. Such positioning of the wheel-positioning mechanism in the lower part 114 of the bot 100 without significantly interfering with, impinging on or obstructing the container-receiving space 120 or any containers 10 in or moving into or out of the container-receiving space 120 may be enabled by the selected components and the selected orientation of components allowing the wheel-positioning mechanism to have one or more relatively narrow dimensions, as described above. In other embodiments, one or more components of the wheel-positioning mechanism may be positioned in the upper part 112 of the bot 100.

Advantageously, each of the four linear actuators may be actuated independently of one another to control the positioning of the pairs of wheels 116, 118 independently of one another. This may enable various advantageous functionality, such as the raising and lowering of individual pairs of wheels during motion of the bot 100 to accommodate imperfections in the surfaces of tracks 22a, 22b, and/or to accommodate deliberate curvature of the tracks 22a, 22b. The independent actuability of the linear actuators may for example facilitate or make easier travel over curved and/or banked tracks as well as over substantially straight and orthogonally-arranged tracks such as those illustrated on the storage grid 1 illustrated in FIG. 1. The wheel-positioning mechanism may furthermore include means for pivoting wheels relative to their respective panels and/or relative to the body 102 of the bot 100 to help accommodate curved tracks 22a, 22b. This may for instance include steering means for turning the wheels to change the direction of facing of the wheels and/or leaning means configured to allow the wheels to pivot about a respective axis running substantially along or parallel to the direction of travel of the bot 100. These respective axes may for example run through the centres of pairs of the wheels.

The extension and retraction of the linear actuators or alternative wheel-engaging means may be controlled electrically, mechanically, pneumatically or otherwise, to control the raising and lowering of the panels on which the respective wheels are mounted.

In some examples, the lengths of the linkage 312 either side of the second pivot point P2 may be chosen to optimise lever action or turning moment. For example, the distance between the pivoting connector 314 (i.e. the point on the linkage 312 at which the force of the linear actuator is applied) and the second pivot point P2 may be maximised, to achieve a greater turning moment from the same force provided by the linear actuator. Alternatively or additionally, the distance between the roller 310 and the second pivot point P2 may be minimised, to reduce the turning moment from the weight of the frame 320, panel 324 and wheels. In other words, the lengths of the linkage 312 either side of the second pivot point P2 may be chosen to amplify the effects of the force provided by the linear actuator.

In the illustrated embodiment, the linkage 312 is straight. In other embodiments, the linkage may not be straight. It may, for example, be angled (which in this context means having at least two differently orientated (i.e. mutually angled) sections, one for instance on either side of the second pivot point P2, one or more of which may be straight) or curved. When the linkage is angled, a portion of the linkage below the second pivot point P2 may be constrained such that it cannot go past the vertical or can only go a small angle (e.g. less than 5° or preferably less than 1°) past the vertical, as described above in the context of a non-angled linkage 312. As described above, the linkage may be held with the portion of the linkage below the second pivot point P2 at or near the vertical by one or more end stops, braking means or latching means. Advantageously, having an angled or curved linkage may enable additional optimisation of the turning moment provided by the linear actuator. For example, an appropriate angling of the linkage may make it possible to arrange the wheel-positioning mechanism such that the linear actuator applies a force to the linkage at or approximately at 90° to the linkage more of the time during movement of the linkage or at a more critical time during the linear actuator's application of force to the linkage (e.g. when the linear actuator first applies force to the linkage to move the linkage away from the configuration in which the portion of the linkage below the second pivot point P2 is substantially vertical, and/or when the linkage is approaching the farthest extent of its rotation such that the corresponding wheels are reaching their most elevated position), thus maximising the turning moment or torque generated by virtue of the linear actuator's force or optimising the time at which the linear actuator can provide the maximum turning moment or torque (e.g. to apply the maximum turning moment at a relatively more important time). This may help improve energy efficiency, reduce the time taken for the linear actuator to raise the respective wheels, and/or reduce the power requirements of the linear actuator.

An angled or curved linkage may furthermore provide advantages in terms of an over-centre locking configuration of the linkage and its connected components. An angled or curved linkage may also reduce the space taken up by the wheel-positioning mechanism (e.g. in the x-direction in the case of the first linear actuator 188 or the third linear actuator, the y-direction in the case of the second linear actuator 189 or the fourth linear actuator, and/or the z-direction in the case of any of the linear actuators), which may allow more space for other components housed within the body 102 of the bot 100, or for the container-receiving space 120. Increasing the size of the container-receiving space 120 may advantageously mean that the bot 100 can accommodate a larger container 10, which may increase the number and/or volume of items that can be stored in the containers 10 and manoeuvred by the bot 100.

Further optimisation of turning moments provided by the linear actuators may be achieved through the relative positioning of pivot points P1 and P2. For example, appropriate relative positioning of pivot points P1 and P2 may mean that the linear actuator applies a force to the linkage at or approximately at 90° to the linkage more of the time or at a more critical time during the linear actuator's application of force to the linkage (e.g. when the linear actuator first applies force to the linkage to move the linkage away from the configuration in which at least the portion of the linkage below the second pivot point P2 moves away from the vertical, and/or when the linkage is approaching the farthest extent of its rotation such that the corresponding wheels are reaching their most elevated position), thus maximising the turning moment or torque generated by virtue of the linear actuator's force.

The pivoting connector 314 illustrated in FIG. 2 to FIG. 4 may be or include an integral part of the extending/retracting member 316, and may include further components. For example, the pivoting connector 314 may include a pair of apertured forks which are located at an end of the extending/retracting member 316, and a pin which passes through the apertures of the forks and through a corresponding aperture in the linkage 312. In such an embodiment, the pivoting connector 314 and the upper end of the linkage 312 may be constrained to move translationally together by the pin.

In the illustrated embodiment, the fully retracted configuration of the linear actuator and its associated components corresponds to a “wheels lowered” configuration and the fully extended configuration of the linear actuator and its associated components corresponds to a “wheels raised” configuration. This may be particularly advantageous if the linear actuator can produce greater extension force than retraction force. However, in other embodiments, those configurations may be reversed, i.e. the fully retracted configuration of the linear actuator and its associated components may correspond to a “wheels raised” configuration and the fully extended configuration of the linear actuator and its associated components may correspond to a “wheels lowered” configuration. In one example of such an arrangement, when the linear actuator is in the fully retracted configuration, the linkage may be in a pivoted position such that the second (lower) end of the linkage (to which the roller is rotatably attached) is to the left of the second pivot point P2 and relatively high in the z-direction. As the linear actuator extends the extending/retracting member out of the housing towards the extended configuration, the roller moves in an arc about pivot point P2 downwards and to the right as the linkage rotates about pivot point P2. The linkage may stop rotating (e.g. due to braking means or one or more end stops, as discussed above) when at least the lower portion of the linkage (below the pivot point P2) reaches or just passes a substantially vertical orientation, at which point the roller may be at the lowest point of its arc. The corresponding frame, panel and wheels may therefore be in their lowered configuration. To move the wheels from the lowered configuration to their raised configuration, the linear actuator may retract the extension/retraction member, causing the linkage to move away from the configuration in which at least the lower portion of the linkage is in the vertical position. The roller therefore moves to the left and upwards as the linkage rotates about pivot point P2, applying an upwards force to the frame, panel and wheels and moving the wheels into the raised configuration.

As noted above, the extending/retracting member 316 may still be at least partly within the housing 318 when the linear actuator and other components are in the “fully extended” configuration. Analogously, at least part of the extending/retracting member 316 may still protrude from the housing 318 when the linear actuator and other components are in the “fully retracted” configuration. The fullness of the extension and retraction may be defined based on intended maximum raising or lowering of the corresponding wheels 116, 118. The fully extended and retracted configurations may be delimited by one or more end stops, as described above, or otherwise.

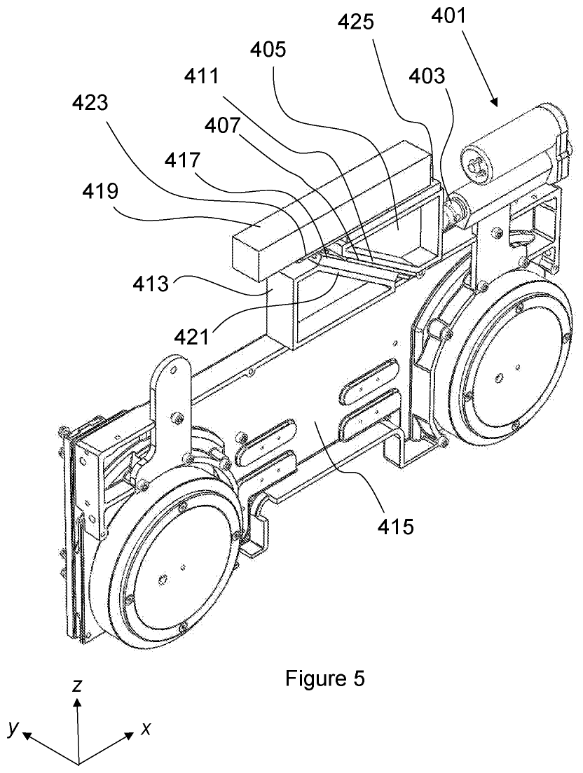

A further embodiment of a wheel-positioning mechanism is illustrated in FIG. 5. The example of FIG. 5 includes a linear actuator 401 which is configured to be mounted on a respective side of a bot 100. Unlike in the examples of FIG. 2 to FIG. 4, the linear actuator 401 is configured to be fixedly (non-pivotably) mounted on the respective side of the bot 100. The linear actuator 401 is configured to apply, via an extending and retracting member 403, an extending and retracting force to a first wedge 405 to drive the first wedge 405 in a direction substantially along or parallel to the x-axis illustrated in FIG. 5. A first linear guide 407 including an approximately T-shaped protrusion is mounted on a sloping surface 411 of the first wedge 405. A second wedge 413 is mounted on a panel 415 which is substantially the same in function as the panel 324 illustrated in the examples of FIG. 2 to FIG. 4. A second linear guide 417 including an approximately T-shaped recess is mounted on a sloping surface 421 of the second wedge 413. The approximately T-shaped recess of the second linear guide 417 is sized, shaped and configured to slidably receive the approximately T-shaped protrusion of the first linear guide 407. In other words, the T-shaped protrusion and the T-shaped recess dovetail, engaging one another, in such a way that the T-shaped protrusion is able to slide in either direction along and at least partly within the T-shaped recess. In some embodiments, one or more “end stop” features may be provided (e.g. at a longitudinal end of the T-shaped recess) to limit the distance that the T-shaped protrusion can slide.

The panel 415 is slidably mounted on the body 102 of the bot 100 such that the panel 415 can slide up and down (i.e. in the z-direction) but cannot move in any other direction (i.e. cannot move in the x-direction or the y-direction). The panel 415 may for example be slidably mounted on shafts in a similar way to how panel 324 is mounted, as described above, or may be differently mounted but achieving a similar effect of only allowing the panel 415 to move in the z-direction. The panel 415 may additionally or alternatively include one or more linear guides or other features arranged to interact with one or more corresponding linear guides mounted on the body 102 of the bot 100.

When the linear actuator 401 applies an extending force to the first wedge 405 via the extending and retracting member 403, the movement of the first wedge 405 is further constrained by a block 419 which is fixedly (non-movably) mounted on the body 102 of the bot 100. The block 419 constrains the first wedge 405 such that the first wedge 405 cannot substantially move in the z-direction, by virtue of the block 419 being fixedly mounted on the body 102 of the bot 100 immediately above the first wedge 405. In other words, the block 419 obstructs movement of the first wedge 405 in the z-direction. The block 419 may also contribute to constraining the first wedge 405 such that the first wedge 405 cannot substantially move in the y-direction. In the illustrated embodiment, this is achieved through the interaction of a third linear guide 423 mounted on the underside of the block 419 and a fourth linear guide 425 mounted on the top surface of the first wedge 405. The third and fourth linear guides 423, 425 are substantially similar to the first and second linear guides 407, 417, one including a T-shaped protrusion extending longitudinally along its respective mounting component and the other including a T-shaped recess extending longitudinally along its respective mounting component. As described above in the context of the first and second linear guides, the T-shaped protrusion of the third or fourth linear guide 423, 425 may be arranged to slide at least partially within the T-shaped recess of the fourth or third linear guide 425, 423. The longitudinal engagement of the T-shaped protrusion and the T-shaped recess may help to ensure that the first wedge 405 cannot substantially move in the y-direction, since the block 419 (which is fixedly mounted on the body 102 of the bot 100) cannot move in the y-direction, and the first wedge 405's movement in the y-direction relative to the block 419 is constrained by the engagement of the T-shaped protrusion and the T-shaped recess.

Therefore, as the linear actuator 401 applies an extending force to the first wedge 405 via the extending/retracting member 403, the first wedge 405 is moved substantially along or parallel to the x-direction only. The first wedge 405 applies a corresponding force to the second wedge 413 via the first and second linear guides 407, 417. The force applied to the second wedge 413 by the first wedge 405 has components in the x-direction and the z-direction (by virtue of the angles of the sloped surfaces 411 and 421 on which the first and second linear guides 407, 417 are mounted). Since the second wedge 413 is mounted on the panel 415 and the panel 415 is mounted on the body 102 of the bot 100 in such a way that the panel 415 can slide in the z-direction only, the x-direction component of the force applied to the second wedge 413 is counteracted by the shafts, linear sliders and/or other mounting means via which the panel 415 is mounted on the body 102 of the bot 100. The z-direction component of the force applied to the second wedge 413 causes the second wedge 413 and the panel 415 to move downwards relative to the body 102 of the bot 100. This causes the wheels (which are mounted on the panel 415, as described above in the context of FIG. 2 to FIG. 4) to move downwards, e.g. into contact with tracks 22a or 22b. The T-shaped protrusion of the first linear guide 407 slides within the T-shaped recess of the second linear slider 417 as the first wedge 405 slides in the x-direction (to the left in FIG. 5) and the second wedge 413 slides in the z-direction (down in FIG. 5).

When the linear actuator 401 applies a retracting force to the first wedge 405 via the extending/retracting member 403, the first wedge 405 is moved along or substantially parallel to the x-axis, but in the opposite direction from before (to the right in FIG. 5). The first wedge 405 applies a corresponding force to the second wedge 413 via the first and second linear guides 407, 417. In particular, the rightward movement of the first wedge 405 causes the T-shaped protrusion of the first linear guide 407 to apply a force to the T-shaped recess of the second linear guide 417, which is mounted on the second wedge 413. The force applied to the second wedge 413 by the first wedge 405 has components in the x-direction (to the right) and the z-direction (upwards), by virtue of the angles of the sloped surfaces 411 and 421 on which the first and second linear guides 407, 417 are mounted. Since the second wedge 413 is mounted on the panel 415 and the panel 415 is mounted on the body 102 of the bot 100 in such a way that the panel 415 can slide in the z-direction only, the x-direction component of the force applied to the second wedge 413 is counteracted by the shafts, linear sliders or other mounting means via which the panel 415 is mounted on the body 102 of the bot 100. The z-direction component of the force applied to the second wedge 413 causes the second wedge 413 and the panel 415 to move upwards relative to the body 102 of the bot 100. This causes the wheels (which are mounted on the panel 415, as described above in the context of FIG. 2 to FIG. 4) to move upwards, e.g. out of contact with tracks 22a or 22b. The T-shaped protrusion of the first linear guide 407 slides within the T-shaped recess of the second linear slider 417 as the first wedge 405 slides in the x-direction (to the right in FIG. 5) and the second wedge 413 slides in the z-direction (up in FIG. 5).

Although in the above-described example the T-shaped protrusion is on the first linear guide 407 and the T-shaped recess is on the second linear guide 417, in other examples the T-shaped protrusion may be on the second linear guide 417 and the T-shaped recess may be on the first linear guide 407. Furthermore, in some examples, a different shape or cross-sectional profile of protrusion and/or recess may be used, provided that the protrusion and recess arrangement still enables the first wedge 405 to raise the second wedge 413 when the first wedge 405 is retracted by the linear actuator 401. For example, the cross section of the protrusion may have a spur or stalk which culminates in a circular, oval, square or other shaped portion, the shaped portion being arranged to engage with a corresponding shaped recess in the other guide. The third and fourth linear guides 423, 425 may similarly have one or more dovetailing features, which may be arranged in any manner which enables them to limit movement of the corresponding first wedge 405 as described above.

Advantageously, in the examples illustrated in FIG. 2 to FIG. 5, the linear actuators of the wheel-positioning mechanism are orientated non-vertically. In this context, the word “orientate” and its derivatives refer to the direction of actuation (i.e. extension and retraction) of a linear actuator, and/or to a direction of pointing of the longitudinal axis of a linear actuator. More particularly, the linear actuator in the embodiment illustrated in FIG. 5 is orientated substantially horizontally. The linear actuators illustrated in FIG. 2 to FIG. 4 may also be orientated substantially horizontally but, as previously described, are pivotably mounted, such that each linear actuator can occupy a range of orientations. The linear actuators in FIG. 2 to FIG. 4 may, more specifically, be able to occupy a range of orientations between the horizontal and approaching the vertical, or, more particularly, between the horizontal and 45° from the horizontal. This non-vertical orientation of the linear actuators advantageously means that vertical space consumed by the linear actuators is minimised, allowing more space in the upper section 112 for other components. The non-vertical orientation of the linear actuators may advantageously mean that the housing and the extending/retracting member of a given linear actuator can fit, in the fully extended configuration, substantially within the lower portion 114 of the body 102 of the bot 100, allowing more room for operation components (e.g. a larger battery 191) in the upper portion 112 of the body 102 of the bot 100. Furthermore, as described above, the non-vertical orientation of the linear actuators may allow mechanical advantage to be exploited, e.g. using a pivoting lever (such as linkage 312) and/or another rotational component which allows a greater turning moment to be provided using the linear actuator, or using gearing means to magnify an input from the linear actuator to an output for lifting the wheels relative to the body of the bot.

Although in the above paragraphs third and fourth linear guides 423, 425 were described and illustrated as constraining movement of the first wedge 405 such that it cannot move in the y-direction, one or more further not-illustrated components (such as a side panel of the bot 100) may be provided to help constrain movement of the first wedge 405 in addition or as an alternative to the linear guides.

One or more of the linear guides may be made of or include a layer of low-friction material to help promote sliding of the respective linear guides relative to each other.

Although a new reference numeral (401) has been used to identify the linear actuator illustrated in FIG. 5, the linear actuator 401 may be substantially the same as either or both of the linear actuators 188, 189 illustrated in the examples of FIG. 2 to FIG. 4. Instead of a pivoting connector 314, the linear actuator 401 illustrated in FIG. 5 has a first wedge 405 attached to a distal end of an extending/retracting member 403.

A further embodiment of a bot 100 with a wheel-positioning mechanism comprising a non-vertically mounted linear actuator will now be described. In the further embodiment, one or more of the wheels in the wheel assembly (i.e. one or more of the wheels 116 in the first set of wheels 116 and/or one or more of the wheels 118 in the second set of wheels 118) is pivotably mounted on the body 102 of the bot 100 at a pivot point which is offset, in the plane of the wheel, from the axis of the wheel about which the wheel rotates as the bot 100 moves along tracks 22a or 22b. The pivot point may be described as eccentric, i.e. away from the centre of the wheel. A linear actuator (such as the linear actuators 318, 401 illustrated in FIG. 2 to FIG. 5, or a different form of linear actuator) is pivotably mounted on the body 102 of the bot 100 and is connected, at a distal end of an extending/retracting member of the linear actuator, to the pivotably mounted wheel 116 or 118 such that extension or retraction of the extending/retracting member causes the wheel 116, 118 to pivot about the eccentric pivot point. This pivoting causes the wheel 116, 118 to rotate eccentrically (i.e. about the eccentric pivot point), lowering or raising the lowest point of the wheel 116, 118 as the wheel 116, 118 traces an arc about the eccentric pivot point. The lowering or raising of the lowest point of the wheel 116, 118 as the linear actuator is extended or retracted allows the wheel to be brought into or out of contact with a corresponding track 22a, 22b, to facilitate a change in direction of movement of the bot 100 along the tracks 22a, 22b of the storage grid 1. The other wheel 116, 118 on the same side of the bot 100 as the previously described wheel 116, 118 may also be pivotably mounted on the body 102 of the bot 100 about an eccentric pivot point and may be provided with a respective linear actuator which is also pivotably mounted on the body 102 of the bot 100 and connected, at a distal end of its extending/retracting member, to the pivotably mounted wheel 116, 118. The two linear actuators may be controlled to extend or retract substantially simultaneously to lower or raise the two wheels 116, 118 at substantially the same time. Wheels 116, 118 on one or more of the other sides of the bot 100 may be similarly pivotably mounted with respective pivotably mounted linear actuators, or may use one of the other types of wheel-positioning mechanism described in this document, or may be non-movably fixed to the body 102 of the bot 100, relying instead on raising or lowering the wheels on the adjacent sides to cause a lowering or raising of the body 102 of the bot 100. This embodiment therefore comprises a wheel-positioning mechanism and wheel-engaging means which may be described as eccentric-rotation based. Eccentric rotation of one or more of the components of the wheel-positioning mechanism gives rise to raising and/or lowering of wheels 116, 118.

In a variation of the further embodiment described in the previous paragraph, a pair of wheels 116, 118 on a single side of the body 102 of the bot 100 may both be eccentrically mounted on the body 102 of the bot 100 (i.e. about respective points which are offset from the wheels' centres in the planes of the wheels), and a single linear actuator may be connected to and between the two wheels, e.g. to points on the opposite sides of the centres of the wheels from the eccentric mounting points. Extension or retraction of the single linear actuator may therefore cause both of the wheels 116, 118 to rotate eccentrically about their respective eccentric mounting points, causing a lowering or raising of the lowest points of the wheel 116, 118. This may allow the wheels 116, 118 to be brought into or taken out of contact with tracks 22a, 22b, to facilitate a change in direction of movement of the bot 100. The other pairs of wheels on the bot 100 may be similarly eccentrically mounted and each provided with a respective single linear actuator which is connected to both wheels of the respective pair, or be provided with one or more of the other wheel-positioning mechanisms described in this document. In a further variation, two linear actuators may be rigidly connected to one another between the wheels 116, 118. This may advantageously offer greater extension and/or retraction than a single linear actuator. This variation therefore also comprises a wheel-positioning mechanism and wheel-engaging means which may be described as eccentric-rotation based. Eccentric rotation of one or more of the components of the wheel-positioning mechanism gives rise to raising and/or lowering of wheels 116, 118.

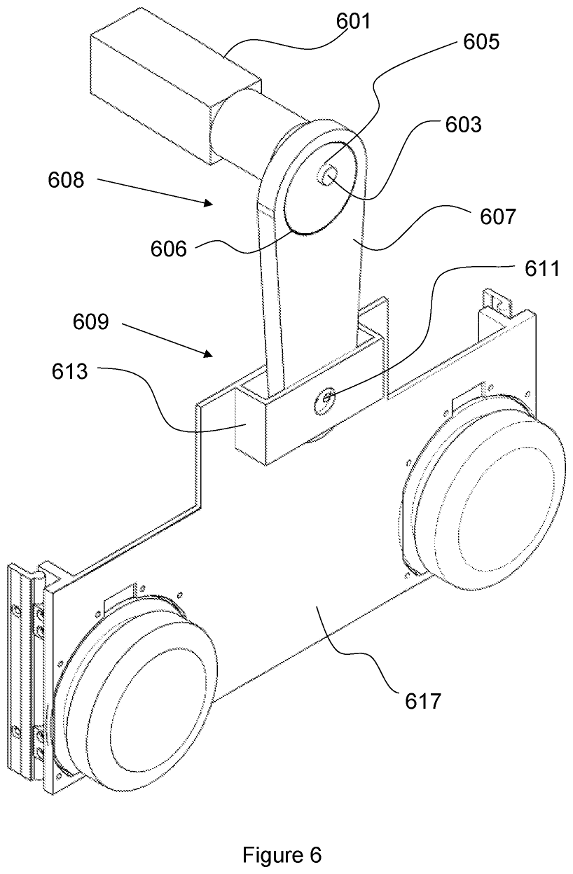

FIG. 6 illustrates a further example of a wheel-positioning mechanism configured to raise and lower wheels relative to a body 102 of a bot 100. In the illustrated example, a rotary motor 601 is provided which is configured to be mounted on and/or in the body 102 of a bot 100. A rotating output axle 603 of the motor 601 is configured to be inserted into an aperture 605 in a bearing 606. The bearing 606 is rotatably mounted within a connector 607 towards a first end 608 of the connector 607. The output axle 603 and the aperture 605 may be configured to enable rotation to be transmitted between the output axle 603 and the bearing 606 via the aperture 605. For example, the output axle 603 and the aperture 605 may have high-friction surfaces, e.g. knurled, stippled or otherwise textured surfaces, to provide sufficient friction between the two surfaces to enable rotational force to be transferred from the output axle 603 to the aperture 605 and thus the bearing 606. In some embodiments, the surfaces of the output axle 603 and the aperture 605 may be splined and/or grooved to enable rotational force to be transferred. In some embodiments, a high-friction coating may be applied to the surfaces of the output axle 603 and the aperture 605. In some embodiments, an interference fit between the output axle 603 and the aperture 605 may be sufficient to enable transfer of rotational force.

When the output axle 603 is engaged with the aperture 605, the motor 601 rotates the output axle 603 about the longitudinal axis of the output axle 603. The rotation of the output axle 603 causes the bearing 606 to rotate about the longitudinal axis of the output axle 603 and the centre of aperture 605. Since, as illustrated in FIG. 6, the centre of aperture 605 is eccentric (i.e. offset from the centre of the bearing 606), rotating the bearing 606 about the centre of the aperture 605 causes a raising or lowering of the centre of the bearing 606, i.e. an eccentric rotation of the bearing 606. The raising or lowering of the centre of the bearing 606 as the bearing rotates within connector 607 leads to a corresponding raising or lowering of connector 607. In the illustrated embodiment, a further bearing (not visible behind frame 613) is rotatably mounted in the connector 607 towards a second, opposite end 609 of the connector 607 from the bearing 606. The further bearing is connected at one or more connection points 611 to a frame 613 which is mounted on panel 617 (portion of frame 613 cut out to show connector 611 in further bearing). The connection points 611 may for example be apertures in the frame 613 through which bolts, pins or other fastening means may be driven to fix the frame 613 and the further bearing together such that the frame 613 and the further bearing are constrained to move translationally together. The panel 617 may be substantially similar in function to the panels 324, 415 discussed and illustrated in the contexts of FIG. 2 to FIG. 4 and FIG. 5.

As the output axle 603 is rotated about its longitudinal axis, causing the bearing 606 to rotate eccentrically about the centre of aperture 605 and thus the connector 607 to move up or down and, at the first (upper) end 608, from side to side to accommodate the eccentric rotation of the bearing 606, the further bearing rotates within the connector 607 to accommodate the side-to-side motion of the upper end of the connector 607 and moves up or down (with the connector 607 and with the frame 613) to accommodate the up-or-down motion of the connector 607. The movement up or down of the further bearing causes the frame 613 and the panel 617 to move up or down. Wheels are rotatably but otherwise fixedly mounted on the panel 617, such that the wheels move up or down with the frame 613 and the panel 617. Thus the rotation of the output axle 603 of motor 601 causes a raising or lowering of the wheels mounted on the panel 617, to bring the wheels out of or into contact with tracks 22a, 22b of a storage grid 1.

The wheel-positioning mechanism and wheel-engaging means illustrated in FIG. 6 may therefore be referred to as an eccentric-rotation-based wheel-positioning mechanism/wheel-engaging means, since the rotating bearing 606 rotates about an eccentric axis to cause the raising or lowering of the connector 607 in which it is rotatably mounted, and thus the raising or lowering of the wheels to which the connector 607 is indirectly connected.

In a modified embodiment of the wheel-positioning mechanism illustrated in FIG. 6, the motor 601 may have an output axle which rotates about an axis which is offset from the centre of the output axle. The output axle of the motor traces arcs of a circle when the motor rotates the output axle. The output axle of the motor may be rotatably inserted into an aperture in the first (upper) end of connector 607. As the output axle of the motor is rotated by the motor, the output axle moves the aperture of the connector 607 through the arcs of the circle through which the output axle moves. This raises and lowers the first (upper) end of the connector 607, causing a corresponding raising and lowering of the frame 613 and panel 617, in a similar way to the raising and lowering of the connector 607 caused in the embodiment illustrated in FIG. 6. This modified embodiment may therefore also be referred to as an eccentric-rotation-based wheel-positioning mechanism/wheel-engaging means. It may be regarded as similar to a crank and cam action.

A bot 100 may be provided with four such eccentric-cam-based wheel-positioning mechanisms to cause raising and lowering of the pairs of wheels on the respective four sides of the bot 100. Alternatively, a bot 100 may be provided with one or more eccentric-cam-based wheel-positioning mechanisms as illustrated in FIG. 6, and one or more alternative wheel-positioning mechanisms, such as the wheel-positioning mechanism illustrated in FIG. 2 to FIG. 5.

Although the example of an eccentric-rotation-based wheel-positioning mechanism illustrated in FIG. 6 includes a motor 601 configured to rotate the output axle 603 and the bearing 606 engaged with the output axle 603 about the longitudinal axis of the output axle 603, other examples may include a different rotation means to provide eccentric rotation of one or more components leading to a raising and lowering of wheels of a bot. For example, in some embodiments, a non-vertically mounted linear actuator (such as the linear actuators 188, 189 illustrated in FIG. 2 to FIG. 4) may be pivotably mounted on the body 102 of the bot 100 and may be connected at a distal end of an extending/retracting member of the linear actuator to the rotatable bearing 606 using a pin which protrudes through one of the apertures in bearing 606. A further pin mounted on the body 102 of the bot 100 may protrude through one of the apertures in the bearing 606. Extension and/or retraction of the linear actuator may then cause the bearing 606 to rotate eccentrically about the pin mounted on the body 102, causing a raising or lowering and a side-to-side motion of the connector 607 as the bearing 606 rotates. The raising or lowering of the connector 607 due to the eccentric rotation of the bearing 606 may cause a corresponding raising or lowering of a panel 617 on which the wheels are mounted, thereby raising or lowering the wheels out of or into contact with a track 22a, 22b. This embodiment may therefore also be referred to as having an eccentric-rotation-based wheel-positioning mechanism/wheel-engaging means.

In another embodiment, a motor or other rotation-generating means may be mounted on the body 102 of the bot 100 and connected via a shaft to an eccentrically mounted wheel (e.g. at a point on an opposite side of the wheel from the eccentric mounting point). Rotation of the rotation-generating means may cause the shaft to apply a force to the wheel to rotate the wheel eccentrically about its eccentric mounting point, causing a raising or lowering of the lowest point of the wheel. In some embodiments, the rotation-generating means may be connected via shafts to two wheels on a single side of the bot 100. Rotation of the rotation-generating means may cause eccentric rotation of both of the wheels, leading to raising or lowering of the lowest points of the two wheels simultaneously, enabling the wheels to be brought into or out of contact with a track 22a, 22b. Since the wheels rotate about eccentric mounting points, this embodiment too may be referred to as having an eccentric-rotation-based wheel-positioning mechanism/wheel-engaging means.

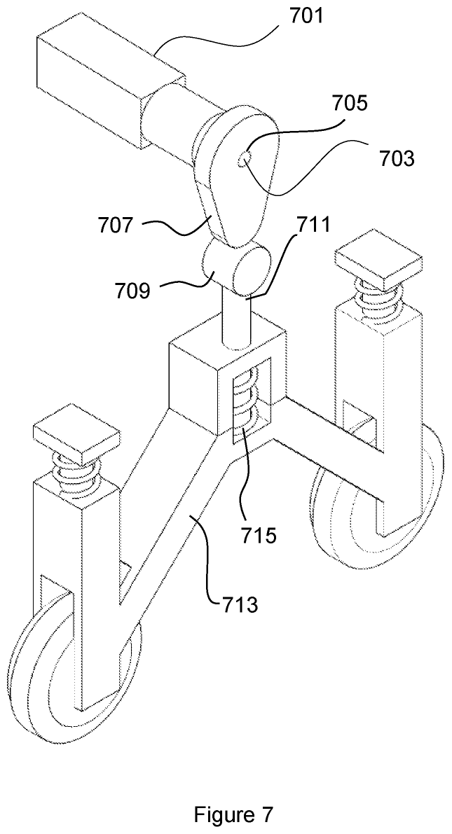

A variation of a rotation-based wheel-positioning mechanism is illustrated in FIG. 7. The illustrated mechanism incorporates a motor 701 or other rotation-generating means, similar to that shown in FIG. 6. An output 703 of the motor 701 is located in a hole 705 in a cam 707. The cam 707 abuts a cylinder 709 mounted on a shaft 711. The shaft 711 is connected to a wheel-mounting frame 713. A spring 715 biases the shaft 711, cylinder 709 and wheel-mounting frame 713 upwards. The cam 707, under the action of the motor 701 and motor output 703, controls the extent to which the spring 715 can continue raising the wheel-mounting frame 713. In FIG. 7 the cam 707 is illustrated in its “longest” configuration. In other words, the cam 707's long axis is substantially vertically orientated and therefore the cylinder 709, shaft 711 and wheel-mounting frame 713 are lowered to the fullest extent possible. This may for example be the configuration required for the wheels mounted on the wheel-mounting frame 713 to be in contact with tracks 22 of a storage system 1. The spring 715 is held at its minimum extension and maximum potential energy. If the cam 707 is rotated away from this substantially vertical orientation, the cylinder 709, shaft 711 and wheel-mounting assembly 713 will rise under the action of the spring 715 as it converts potential energy into extension. Advantageously, the illustrated arrangement may allow a relatively rapid raising and lowering of the corresponding wheels, since, depending on the specific dimensions and other physical characteristics of the cam 707 and the cylinder 709, a small change in the angle of the long axis of the cam 707 to the vertical may effect a relatively large change in the vertical displacement of the wheel-mounting frame 713. It may furthermore be a relatively low-energy way of raising and lowering the corresponding wheels, since the raising happens under the action of the spring 715 and the lowering happens under the rotational action of the motor 701, which may be geared to the overall advantage of the system. Depending on the desired configuration, the cylinder 709 may be rotatably mounted such that, as the angle of the long axis of cam 707 changes, the cylinder rotates along the outer face of the cam 707. In other embodiments, the engaging surfaces of the cam 707 and the cylinder 709 may be configured to slide over one another. In such an example, the surfaces may be smooth to allow easy sliding, or may be provided with a desired level of friction to provide more controlled relative movement of the cam 707 and the cylinder 709. The wheel-mounting frame 713 may be mounted on the body 102 of the load-handling device 100 in guides which prevent sideways (lateral) movement of frame 713 but allow vertical movement of the frame 713.

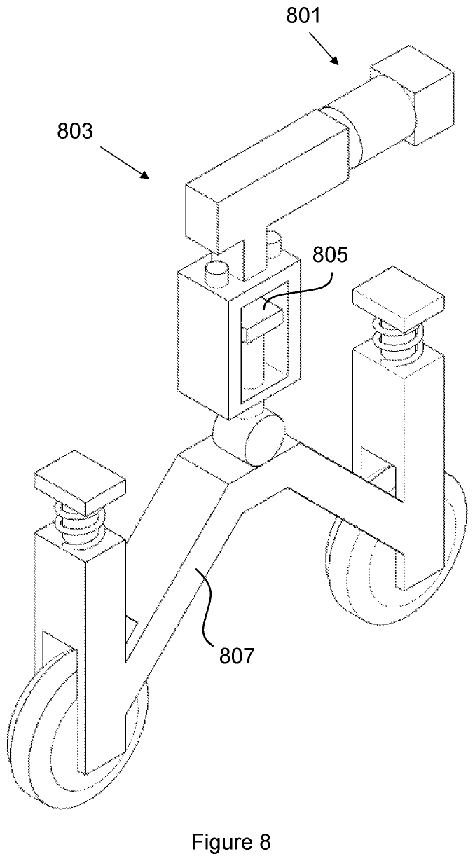

A further example of a wheel-positioning mechanism is illustrated in FIG. 8. In the illustrated example, a pump system 801 provides pressurised fluid (such as a mineral oil or other fluid) to a chamber system 803. The pressure of the fluid within the chamber system 803 controls a force which is applied to a plunger 805. The plunger 805 is connected to a wheel-mounting frame 807 similar to the wheel-mounting frame 713 illustrated in FIG. 7. The force applied to the plunger 805 by the fluid 803 in the chamber system 803 controls the extent to which the wheel-mounting frame 807 is lowered. The plunger 805 may act like a piston, defining a boundary between an upper chamber and a lower chamber within the chamber system 803, the pressures and/or flows of the respective fluids in the upper and lower chambers of the chamber system 803 being controlled under the action of the pump system 801 to control the extent to which the wheel-mounting frame 807 is forced down, lowering the wheels towards the tracks 22 of the storage system 1. In some embodiments, the vertical position of the wheel-mounting frame 807 may be controlled solely by the pump system 801, the chamber system 803 and the plunger 805. In other embodiments, other components or systems may contribute to controlling the vertical position of the wheel-mounting frame 807. For example, in some embodiments, a spring such as the spring 715 illustrated in FIG. 7 may also be provided, to bias the wheel-mounting frame 807 in a given direction. In such cases, the spring and the systems 801, 803 and 805 may oppose each other or may act in the same direction, depending on the specific design choices and requirements. The arrangement illustrated in FIG. 8 may be regarded as a fluid-based wheel-positioning mechanism, comprising a fluid-based wheel-engaging means. Properties of the fluid (such as volume and/or compressibility) may be chosen to optimise the speed of action (i.e. raising and lowering of the wheel-mounting frame 807 and accompanying wheels), the efficiency of action (i.e. the input energy for the pump system 801) and/or other factors.

Some embodiments of load-handling device may include more than one of the above-described types of wheel-positioning mechanism for raising and lowering different pairs of wheels. For example, a load-handling device may include: a wheel-positioning mechanism as illustrated in FIG. 2 to FIG. 4 on a first side of the load-handling device, to raise and lower the first side's pair of wheels; a wheel-positioning mechanism as illustrated in FIG. 5 on a third side of the load-handling device, to raise and lower the third side's pair of wheels; a wheel-positioning mechanism as illustrated in FIG. 6 on a second side of the bot, to raise and lower the second side's pair of wheels; and a wheel-positioning mechanism as illustrated in FIG. 7 on a fourth side of the load-handling device, to raise and lower the fourth side's pair of wheels. Some embodiments may include two different types of wheel-positioning mechanism, e.g. a first type of wheel-positioning mechanism on sides one and two of a load-handling device, and another type of wheel-positioning mechanism on sides three and four of a load-handling device, such that the same type of wheel-positioning mechanism is configured to raise and lower all of the wheels in the first set of wheels 116 and the same type of wheel-positioning mechanism is configured to raise and lower all of the wheels in the second set of wheels 118. Some embodiments may include only one type of wheel-positioning mechanism, e.g. the wheel-positioning mechanism illustrated in FIG. 2 to FIG. 4, which may be present on each side of the load-handling device.

In this document, the language “movement in the n-direction” (and related wording), where n is for example one of x, y and z, is intended to mean movement substantially along or parallel to the n-axis, in either direction (i.e. towards a positive end of the n-axis or towards a negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

1. A load-handling device for lifting and moving containers stacked in stacks in a storage system, the storage system including a plurality of rails or tracks arranged in a grid pattern above the stacks of containers, the load-handling device being configured to move on the rails or tracks above the stacks, the load-handling device comprising:
a body having an upper portion and a lower portion, the upper portion being configured to house one or more operation components, the lower portion being arranged beneath the upper portion, the lower portion including a container-receiving space for accommodating at least one container;
a wheel assembly arranged to support the body, the wheel assembly including a first set of wheels for engaging with a first set of rails or tracks to guide movement of the device in a first direction and a second set of wheels for engaging with a second set of rails or tracks to guide movement of the device in a second direction, wherein the second direction is transverse to the first direction;
a container-lifting mechanism, the container-lifting mechanism including container-engaging means configured to engage a container and lifting means configured to raise and lower the container-engaging means relative to the container-receiving space; and
a wheel-positioning mechanism, the wheel-positioning mechanism including wheel-engaging means for selectively engaging either the first set of wheels with the first set of rails or tracks or the second set of wheels with the second set of rails or tracks, the wheel-engaging means being configured to raise or lower the first set of wheels or the second set of wheels relative to the body, thereby enabling the load-handling device to selectively move in either the first direction or the second direction across the tracks of the storage system,
wherein the wheel-engaging means includes at least one non-vertically-orientated linear actuator.

2. A load-handling device as claimed in claim 1, wherein the wheel-positioning mechanism is located in the lower portion of the body.

3. A load-handling device as claimed in claim 1, wherein the wheel-positioning mechanism is located on or close to an outer surface of the body.

4. A load-handling device as claimed in claim 1, wherein the wheel-engaging means comprises:
a linkage, a pivoting connector and a roller which are configured to move under an action of the at least one non-vertically-orientated linear actuator to raise or lower the first set of wheels or the second set of wheels relative to the body.

5. A load-handling device as claimed in claim 4, wherein the linkage is angled.

6. A load-handling device as claimed in claim 1, wherein the wheel-engaging means comprises:
one or more wedges which are configured to move under an action of the at least one non-vertically-orientated linear actuator to raise or lower the first set of wheels or the second set of wheels relative to the body.

7. A load-handling device as claimed in claim 1, wherein the at least one non-vertically-orientated linear actuator is connected between two wheels on a side of the load-handling device.

8. A load-handling device as claimed in claim 1, wherein the body comprises:
one or more substantially vertically orientated shafts, wherein at least two panels are slidably attached to each of the one or more substantially vertically orientated shafts.

9. A load-handling device as claimed in claim 1, wherein the wheel-positioning mechanism comprises:
one or more braking, latching and/or stopping means configured to constrain movement of the first set of wheels and/or the second set of wheels into or out of a raised configuration or a lowered configuration.

10. A method of enabling a load-handling device having a body and a wheel assembly including a first set of wheels and a second set of wheels to move across transverse sets of tracks of a storage grid, the first set of wheels being moveable relative to the body by a wheel-positioning mechanism having wheel-engaging means, the method comprising:
providing, in a lower portion of the body, wheel-engaging means including at least a first non-vertically-orientated linear actuator configured to raise and lower wheels of the first set of wheels out of and into contact with a first set of the tracks; and
controlling the first non-vertically-orientated linear actuator to lower wheels of the first set of wheels into contact with the first set of the tracks.

11. A method as claimed in claim 10, wherein the second set of wheels is moveable relative to the body of the load-handling device by the wheel-positioning mechanism, the method comprising:
providing, in a lower portion of the body, at least a second non-vertically-orientated linear actuator configured to raise and lower wheels of the second set of wheels out of or into contact with a second set of the tracks; and
controlling the second non-vertically-orientated linear actuator to raise wheels of the second set of wheels out of contact with the tracks of the second set of tracks, to enable the load-handling device to move along the first set of the tracks on the first set of wheels.

12. A computer program for enabling movement of a load-handling device having a body and a wheel assembly including a first set of wheels and a second set of wheels across transverse sets of tracks of a storage grid, the first set of wheels being moveable relative to the body by a wheel-positioning mechanism having wheel-engaging means, the wheel-engaging means including at least a first non-vertically-orientated linear actuator configured to raise and lower wheels of the first set of wheels out of and into contact with a first set of the tracks the computer program comprising instructions which, when the program is executed by a computer, cause the computer to carry out a step of:
controlling at least the first non-vertically-orientated linear actuator to lower wheels of the first set of wheels into contact with the first set of the tracks.

13. A computer program as claimed in claim 12, wherein the second set of wheels is moveable relative to the body of the load-handling device by the wheel-positioning mechanism having wheel-engaging means, the wheel-engaging means additionally including at least a second non-vertically-orientated linear actuator configured to raise and lower wheels of the second set of wheels out of and into contact with a second set of the tracks, the computer program comprising instructions which, when the program is executed by a computer, cause the computer to carry out a step of:
controlling at least the second non-vertically-orientated linear actuator to raise wheels of the second set of wheels out of contact with the second set of the tracks, to enable the load-handling device to move along the first set of the tracks on the first set of wheels.

14. A load-handling device for lifting and moving containers stacked in stacks in a storage system, the storage system including a plurality of rails or tracks arranged in a grid pattern above the stacks of containers, the load-handling device being configured to move on the rails or tracks above the stacks, the load-handling device comprising:
a body having an upper portion and a lower portion, the upper portion being configured to house one or more operation components, the lower portion being arranged beneath the upper portion, the lower portion including a container-receiving space for accommodating at least one container;
a wheel assembly arranged to support the body, the wheel assembly including a first set of wheels for engaging with a first set of rails or tracks to guide movement of the device in a first direction and a second set of wheels for engaging with a second set of rails or tracks to guide movement of the device in a second direction, wherein the second direction is transverse to the first direction;
a container-lifting mechanism, the container-lifting mechanism including container-engaging means configured to engage a container and lifting means configured to raise and lower the container-engaging means relative to the container-receiving space; and
a wheel-positioning mechanism, the wheel-positioning mechanism including wheel-engaging means for selectively engaging either the first set of wheels with the first set of rails or tracks or the second set of wheels with the second set of rails or tracks, the wheel-engaging means including moving means configured to raise or lower the first set of wheels or the second set of wheels relative to the body, thereby enabling the load-handling device to selectively move in either the first direction or the second direction across the tracks of the storage system,
wherein the wheel-engaging means includes an eccentric-rotation-based wheel-engaging means.

15. A load-handling device as claimed in claim 14, wherein the eccentric-rotation-based wheel-engaging means comprises:
a rotation means;
a connector connected to wheels of the first set of wheels or the second set of wheels; and
a bearing rotatably mounted in or on the connector,
wherein the rotation means is configured to cause eccentric rotation of the rotatable bearing, such that the eccentric rotation of the rotatable bearing will cause raising or lowering of the connector and corresponding raising or lowering of the wheels of the first set of wheels or the second set of wheels.

16. A load-handling device as claimed in claim 15, wherein the eccentric-rotation-based wheel-engaging means comprises:
a further bearing which is fixedly connected to the first or second set of wheels, the further bearing being rotatably mounted in or on the connector to accommodate movement of the connector.

17. A load-handling device as claimed in claim 14, wherein the wheel-positioning mechanism is located in the lower portion of the body.

18. A load-handling device as claimed in claim 14, wherein the wheel-positioning mechanism is located on or close to an outer surface of the body.

19. A load-handling device as claimed in claim 14, wherein the body comprises:
one or more substantially vertically orientated shafts, wherein at least two panels are slidably attached to each of the one or more substantially vertically orientated shafts.

20. A load-handling device as claimed in claim 14, wherein the wheel-positioning mechanism comprises:
one or more braking, latching and/or stopping means configured to constrain movement of the first set of wheels and/or the second set of wheels into or out of a raised configuration or a lowered configuration.

21. A method of enabling a load-handling device having a body and a wheel assembly including a first set of wheels and a second set of wheels to move across transverse sets of tracks of a storage grid, the first and second sets of wheels being moveable relative to the body by a wheel-positioning mechanism including wheel-engaging means, the method comprising:
providing, in a lower portion of the body, wheel-engaging means including at least a first eccentric-rotation-based wheel-engaging means configured to raise and lower wheels of the first set of wheels out of and into contact with a first set of the tracks;
controlling the first eccentric-rotation-based wheel-engaging means to lower wheels of the first set of wheels into contact with the first set of the tracks.

22. A method as claimed in claim 21, wherein the second set of wheels is moveable relative to the body of the load-handling device by the wheel-positioning mechanism, the method comprising:
providing, in a lower portion of the body, at least a second eccentric-rotation-based wheel-engaging means configured to raise and lower wheels of the second set of wheels out of and into contact with a second set of the tracks; and
controlling the second eccentric-rotation-based wheel-engaging means to raise wheels of the second set of wheels out of contact with the second set of the tracks, to enable the load-handling device to move along the the first set of the tracks on the first set of wheels.

23. A computer program for enabling movement of a load-handling device having a body and a wheel assembly including a first set of wheels and a second set of wheels across transverse sets of tracks of a storage grid, the first set of wheels being moveable relative to the body by a wheel-positioning mechanism having wheel-engaging means, the wheel-engaging means including at least a first eccentric-rotation-based wheel-engaging means configured to raise and lower wheels of the first set of wheels out of and into contact with a first set of the tracks, the computer program comprising instructions which, when the program is executed by a computer, will cause the computer to carry out the steps of:
controlling at least the first eccentric-cam-based wheel-engaging means to lower wheels of the first set of wheels into contact with the first set of the tracks.

24. A computer program as claimed in claim 23, wherein the second set of wheels is moveable relative to the body of the load-handling device by the wheel-positioning mechanism having wheel-engaging means, the wheel-engaging means including at least a second eccentric-rotation-based wheel-engaging means configured to raise and lower wheels of the second set of wheels out of and into contact with a second set of the tracks, the computer program comprising instructions which, when the program is executed by a computer, will cause the computer to carry out the step of:
controlling at least the second eccentric-rotation-based wheel-engaging means to raise wheels of the second set of wheels out of contact with the second set of the tracks, to enable the load-handling device to move along the first set of the tracks on the first set of wheels.
